(19) United States
(12) Patent Application Publication
(10) Pub. No.: US 2020/0351373 A1
(43) Pub. Date: Nov. 5, 2020

(54) SYSTEMS AND METHODS FOR MANAGING PROFILE UPDATES

(71) Applicants: Munish Kumar Gupta, Bangalore (IN); Rohit Prakash More, Bangalore (IN)

(72) Inventors: Munish Kumar Gupta, Bangalore (IN); Rohit Prakash More, Bangalore (IN)

(21) Appl. No.: 16/403,099

(22) Filed: May 3, 2019

(51) Int. Cl. H04L 29/08; G06F 16/16

(52) U.S. Cl. CPC H04L 67/306; G06F 16/168; G06F 16/164

(57) ABSTRACT

A computer-implemented method comprising extracting profile information for a profile, converting the profile information into a readable file format, and storing the converted profile information. The method may include creating a database file from the converted profile information and copying the database file. The method may include updating the database file copy with profile changes, and loading the updated database file copy to generate an updated profile where the updated database file copy is mapped according to metadata in the updated database file copy. The method may include altering a profile pointer reference to point to the updated database file copy to activate the updated profile, wherein activating the at least one updated profile activates the one or more profile changes.

### FIELD OF THE INVENTION

The invention relates to systems and methods for managing profile updates and, more specifically, managing operator overrides for profile updates.

### BACKGROUND

Certain services may provide clients with client profiles that may contain several values or settings used to process services for the client's business. Some services may use an application containerization model to implement the client profiles. At times it may be desirable for an operator to make changes to the details of a client profile.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 is a flow diagram illustrating an embodiment of a system for managing profile updates as disclosed herein;

FIG. 2 is a flow diagram illustrating another embodiment of the system for managing profile updates disclosed herein;

FIG. 3 is a flow diagram illustrating an embodiment of a profile rollback process related to the system for managing profile updates disclosed herein;

FIG. 4 is a diagram of an embodiment of a service instance of the system for managing profile updates disclosed herein;

FIG. 5 is a flow diagram illustrating an embodiment of a profile change process related to the system for managing profile updates disclosed herein;

FIG. 6 is a process diagram illustrating an embodiment of a practical application of the system for managing profile updates disclosed herein;

FIG. 7 is a flow diagram illustrating an embodiment of a profile transformation process of the system for managing profile updates disclosed herein;

FIG. 8 is a flow diagram illustrating an embodiment of a profile loading process of the system for managing profile updates disclosed herein;

FIG. 9 is a process diagram illustrating an embodiment of a practical activation process of the system for managing profile updates disclosed herein;

FIG. 10 is a process diagram illustrating an embodiment of a profile rollback process of the system for managing profile updates disclosed herein;

FIG. 11 is a process diagram illustrating an embodiment of a profile change process of the system for managing profile updates disclosed herein;

FIG. 12 is a process view illustrating an embodiment of the system for managing profile updates disclosed herein;

FIG. 13 is a schematic diagram illustrating an embodiment of the system for managing profile updates disclosed herein;

FIG. 14 is a flow chart illustrating an embodiment of a method of using the system for managing profile updates disclosed herein;

FIG. 15 is a flow chart illustrating another embodiment of a method of using the system for managing profile updates disclosed herein;

FIG. 16 is a flow chart illustrating another embodiment of a method of using the system for managing profile updates disclosed herein;

FIG. 17 is a schematic illustration of elements of an embodiment of an example computing device;

FIG. 18 is a schematic illustration of elements of an embodiment of a server type computing device;

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In embodiments, the disclosure describes systems and methods for managing client profile updates and overrides. In some embodiments, the disclosure may include a computer-implemented method including extracting profile information and converting the profile information into a readable file format. The method may include transforming the profile information into a database file, and updating a copy of the database file with profile changes. The method may include loading the updated profile database file to generate an updated profile, and activating the profile to reflect the updates or changes.

### DETAILED DESCRIPTION

The present invention now will be described more fully hereinafter with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

In some embodiments, the disclosure describes systems and methods for managing operator overrides and other changes or updates to profiles in a containerized service model. Some businesses may include offering software or other services that include setting up and maintaining one or more profiles for a client or other user. In some embodiments, profiles may include information related to a client's business, settings preferences, software options, etc. In some embodiments, the profiles may reflect configurations of platforms and other systems related to business and processing, such as clients, processors, merchants, payment products, endpoint routing, spend qualification, minimums, etc. Each profile may be stored in one or more databases, or in a distributed file system (DFS). One advantage of a DFS is that its contents may be made available to consuming services on substantially any host. Alternatively, in some embodiments, the profiles may be stored on local file systems where services may be running.

In some embodiments, a business or service provider maintaining profiles may provide transaction processing services for other businesses or individuals through an electronic payment network, risk management services, or other information services. In such embodiments (and others), the information in clients' profiles may be important to the processing activity. For example, profiles may include account numbers, ISO bank identification numbers (BINs), routing BINs, acquirer BINs, agent bank number, agent chain number, store number, terminal number, merchant name, merchant number, merchant category code, etc. In some embodiments, for a range of account numbers (account range), ISO BIN, and routing BIN, there may be a matching record in each profile system. In some embodiments, this disclosure describes how profile data may be transferred from profile systems and consumed during processing.

In some embodiments, the disclosure describes a method comprising extracting profile information for at least one profile from a profile datastore, converting the profile information into a readable file format, and storing the converted profile information in a storage repository. The method may also include creating at least one database file based on the converted profile information, copying the at least one database file to create a database file copy, and updating the database file copy with one or more profile changes to be made to the at least one profile. The method may also include loading the updated database file copy so as to generate at least one updated profile. The updated database file copy may be mapped according to metadata in the updated database file copy. The method may also include altering a profile pointer reference to point to the updated database file copy so as to activate the at least one updated profile. In some embodiments, activating the at least one updated profile may activate the one or more profile changes.

In some embodiments, the disclosure describes a method that may include presenting a graphical user interface to a user where the graphical user interface provides one or more profiles for selection and receiving, via the graphical user interface, a user selection of a profile of the one or more profiles. In response to the user selection of the profile, the method may include generating a profile copy of the user selected profile, presenting the one or more profile change options associated with the user selected profile, and receiving, via the graphical user interface, a user selection of at least one of the one or more profile change options. Based on the user selection of the at least one of the one or more profile change options, the method may include updating the profile copy of the user selected profile to reflect the one or more profile change options and create an updated profile. The method may also include activating, the updated profile so as to implement the user selection of at the least one of the one or more profile change options.

In another embodiment, the disclosure describes a method that may include receiving a trigger for a profile loading process and reading a profile database file and a profile metadata file from a storage repository. The profile database file may be associated with a client profile. The method may also include generating a copy of the profile database file and a copy of the profile metadata file, and storing the copy of the profile database in a distributed file system. The method may include storing the copy of the profile metadata in a configuration repository and identifying one or more requested profile changes associated with the client profile. The method may also include applying the one or more requested profile changes to the copy of the profile database file, and updating the configuration repository based on the applied one or more requested changes associated with the client profile. The method may also include transmitting a command to one or more services associated with the client profile, the command including an indication of changes to the client profile.

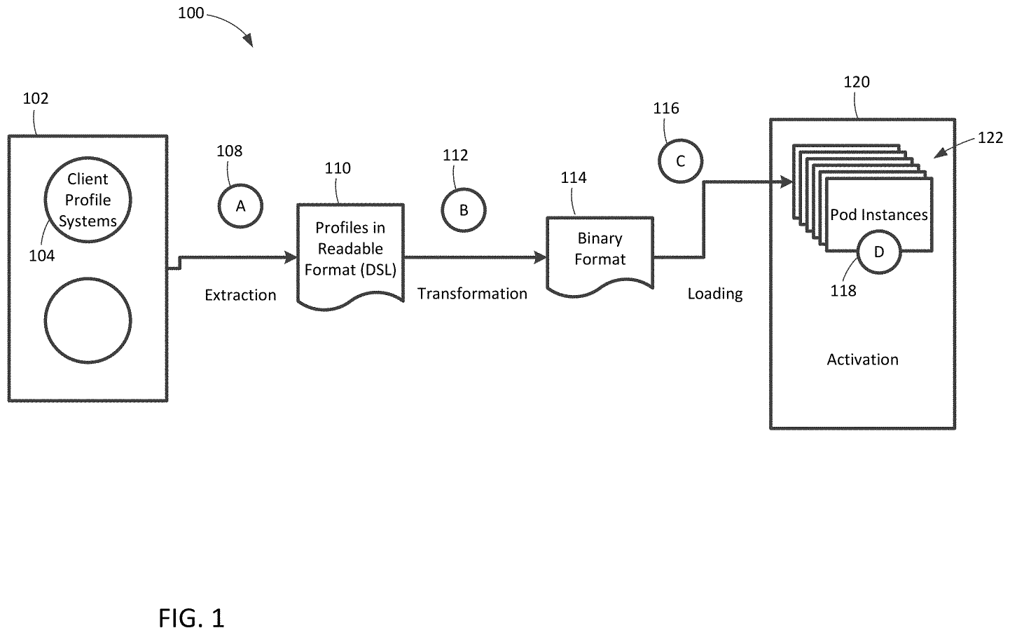

FIG. 1 shows a high level view of an embodiment of system 100 for managing profiles and profile updates. The system may include steps of Extraction 108, Transformation 112, Loading 116, and Activation 118. Additional details for each of these steps are described herein. The system 100 may include a source system 102, where one or more profiles may be stored, such as in a client profile systems 104 storage. At 108, profile data may be extracted from the source system and converted, at 110, into readable format, e.g., domain specific language (DSL), or other intermediate representation. At 112, the system 100 may include transforming the intermediate representation of the profiles (DSLs) into a binary format at 114 and binary data serialization format message types. In some embodiments, the binary structure may be an in-memory datastore structure (i.e., embedded key/value database) that may be read and understood by service instances. In some embodiments, because of high frequency low latency READs, it may be advantageous to store profile information relatively close to code processing a transaction. One way to do so may be by storing and loading profile data in an in-memory datastore, which may include an embedded key-value database optimized for fast reads. In-memory datastore may use a read-only memory mapped data file. In some embodiments, the profile information may be kept in embedded in-memory datastore and re-loaded when a profile is updated. Alternatively (or in addition), an in-memory map may be used in some embodiments. In such embodiments, the profile information may be kept in application programming language runtime data structure (map). When the service starts, the profile information may load in its runtime memory using application programming language appropriate data structures (maps).

In some embodiments, the profile information may be represented in various formats, such as Java Script Object Notation (JSON), .gob files, protobuf, etc. The file format may be significant during profile lookups during some transaction processing. There may be advantages and disadvantages to using different file formats. For example, sometimes JSON encoding/decoding may be CPU and memory expensive operations. In some embodiments, the profile information may be serialized to save on CPU resources and to increase processing efficiency; for example, GOB is a data serialization technique that may work well with data-streams. Protobuf is another serialization technique that may also provide efficiency.

At 116, the system 100 may include loading the profile. In some embodiments, profile loading may include pushing the converted profile binary structure to a shared storage location, such as shared storage 120, which may occur as part of a continuous delivery (CD) process. In some embodiments, the shared storage 120 may include a containerized structure, such as a container orchestrator cluster (e.g., kubernetes) including one or more pods or pod instances 122. The pods may be included in one or more containers, which may make up one or more services. During loading, configuration information of services may be updated to indicate a new profile version, and a signal may be sent to one or more services indicating that a new profile binary is available. In some embodiments, the service may load and/or open the profile binary, where there may be multiple versions of a profile at any given point in the process. The profile information may be in read-only mode, and the service instance may not, in some embodiments, insert or update the profile information.

The system 100 may include profile activation at 118. In some embodiments, profile activation may occur in a phased manner, for example, within a data center to individual service instances. In some embodiments, a signal may be sent to services in a staggered way that may activate a currently-loaded profile version. In some embodiments, the service may ensure that incoming requests use the correct profile version. In some embodiments, transaction requests that may have been processed with one profile version may have a response processed by the same profile version. In such embodiments, the transaction context may include the profile version used to process the request. In some embodiments, once a profile is activated or otherwise available for use within the service instances, profile application programming interfaces (APIs) may be provided to allow consumption of profile data from within the in-memory datastore files or other profile binary.

In some embodiments, service consumers for profile information may be hosted as containers within a container orchestration system for automating application deployment, such as a Kubernetes environment. In some embodiments, a software repository or file storage cluster may be used as a central location by the system in processing pipeline stages to exchange data. In some embodiments, operator changes or overrides may be done for a particular application deployment.

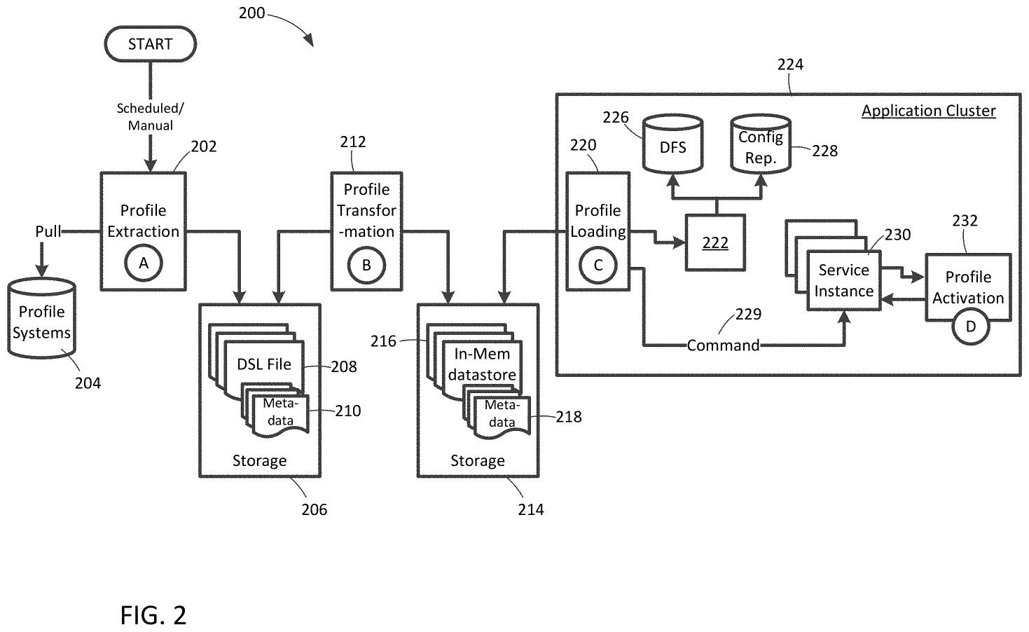

FIG. 2 illustrates a logical view of an embodiment of a system for managing profiles and profile updates 200. Although different reference numbers are used for similar components in the system 200 shown in FIG. 2 as compared to the system 100 shown in FIG. 1, those skilled in the art should understand that many components and subsystem may be interchangeable between systems as appropriate. In some embodiments, the system 200 may include, at 202, extracting one or more profiles from a profile systems storage or database 204. One skilled in the art will recognize that profiles may be stored in any of a variety of manners and/or locations suitable for their application to the system to which they apply. In some embodiments, the profile extraction at 202 may be scheduled, such as hourly, daily, weekly, monthly, etc., but may additionally or alternatively be initiated manually, such as by an operator override as described in greater detail below. In some embodiments, the one or more profiles may be pulled from the profile system database 204 at the scheduled time or in response to a manual instructions.

In some embodiments, profile extraction at 202 may include converting the one or more profiles in to a model that may be understood by the relevant downstream application. For example, in some embodiments, the extracted profiles may be converted into a designated defined DSL format that the application may understand, represented by DSL file 208 in FIG. 2. The DSL files 208 may be stored in DSL storage 206, which may be one or more of a file transfer protocol (FTP) server that may be at a centralized location, a binary repository manager or more general binary repository (e.g., file storage cluster), distributed version-control system (e.g., GIT), or other suitable storage solution. Metadata 210 about the extract may also be stored along with the respective DSL files 208. In some embodiments, the metadata 210 may include information such as a profile name, version, activation date, activation time, etc.

At 212, in some embodiments, the system 200 may include profile transformation, which may include reading the DSL files 208 and metadata 210 and creating relevant data serialization messages (e.g., protocol buffer or “protobuf” messages) and structures (e.g., protobuf structures). In some embodiments, the data serialization structures may be stored as or in embedded key/value database files 216 (e.g., in-memory datastore files) as key-value pairs in entity buckets. The in-memory datastore files 216 may be stored in a storage repository 214, such as a general binary repository (e.g., Artifactory), FTP server, etc. In some embodiments, each profile file 216 may include metadata information 218 such as file name (i.e., in-memory datastore file name), profile information, activation information, version, etc. In some embodiments, the metadata 218 information may be mapped into the relevant human-readable data serialization file or configuration file (e.g., YAML), which may be mapped to the respective in-memory datastore files 216 and stored in the storage repository 214 in combination with the in-memory datastore files. In some embodiments, profile transformation 212 may run on a designated schedule within a designated data center. In some embodiments, profile transformation 212 may be a common activity performed at a central location. The output of the profile transformation 212 may be consumed by application clusters deployed in each of a plurality of individual data centers.

Profile transformation 212 may be triggered in a variety of ways in differing embodiments, or in multiple alternative ways in the same embodiment. In some embodiments, a job process may be programmed to watch for changes in the relevant storage repository 206 folders (e.g., file storage cluster folders) where new DSL files 208 are stored. In some embodiments, when such a watch event is triggered, profile transformation, like at 212, may begin. In other embodiments, the profile transformation process 212 may be triggered by a job scheduler once profile extraction at 202 is completed successfully.

In some embodiments, profile loading 220 may occur as a continuous delivery process. In some embodiments, profile loading 220 may be triggered by watch events, manually initiated, triggered by a job scheduler. In some embodiments, the profile loading 220 process may include reading the in-memory datastore 216 data files and metadata files 218 from the storage repository 214. Profile loading 220 may include, at 222, invoking an API on containerization software, such as Kubernetes. Of course, those skilled in the art will recognize that other suitable software platforms may be used in addition to or as an alternative to those mentioned here. Invoking the API on a containerization software platform cluster 222 may include copying the in-memory datastore data files 216 onto the distributed file system (DFS) 226 which may be attached to an application cluster 224. Profile loading 220 may also include checking for “keeptrack” changes, which may be operator related or previously implemented by an operator, and making those keeptrack changes to the in-memory datastore file. In some embodiments, profile loading 220 may also include invoking an API on the containerization software platform cluster 222 to add profile metadata 218 to a configuration repository 228 that may be attached to the application cluster 224. Profile loading 220 may also include getting a list of service instances within the containerization software platform cluster and broadcasting refresh-profile commands, at 229, to all the service instances 230. In some embodiments, service instances 230 that use the updated profile may access a configuration repository 228 and update those profiles. Service instances 230 that do not use the profile that has been updated may ignore the refresh-profile command 229. In some embodiments, every individual datacenter may have its own profile loading process.

At 232, the system 200 may include profile activation. In some embodiments, profile activation 232 may occur through a profile activation submodule within an overall profile module, as described in further detail below. Profile activation 232 may include the profile submodule using the relevant config profile namespace within the configuration management tool. In some embodiments, when a command from a service instance 230 is available, the profile activation submodule of such a service instance may pick up the data for the profile from the configuration repository 228; for example, the profile metadata 218. The profile activation submodule may read the metadata 218 for the relevant in-memory datastore file associated with the relevant profile. In some embodiments, the profile activation submodule may load the relevant in-memory datastore files from the DFS 226 and map the file in accordance to the respective metadata 218. In some embodiments, the profile activation at 232 may depend on the information in the metadata file 218 and, in particular, the activation timing may be based on an activation timestamp in the metadata. For example, the activation timestamp may indicate future activation at a predetermined activation date and/or time. In such embodiments, the service instance 230 may keep a timer and activate the profile at the predetermined time. In some embodiments, the metadata 218 may indicate that the profile should be immediately activated, such as during rollbacks of previously entered updates or operator overrides (both described in more detail below). At the time of activation, new messages may begin to be processed with the new, updated profile.

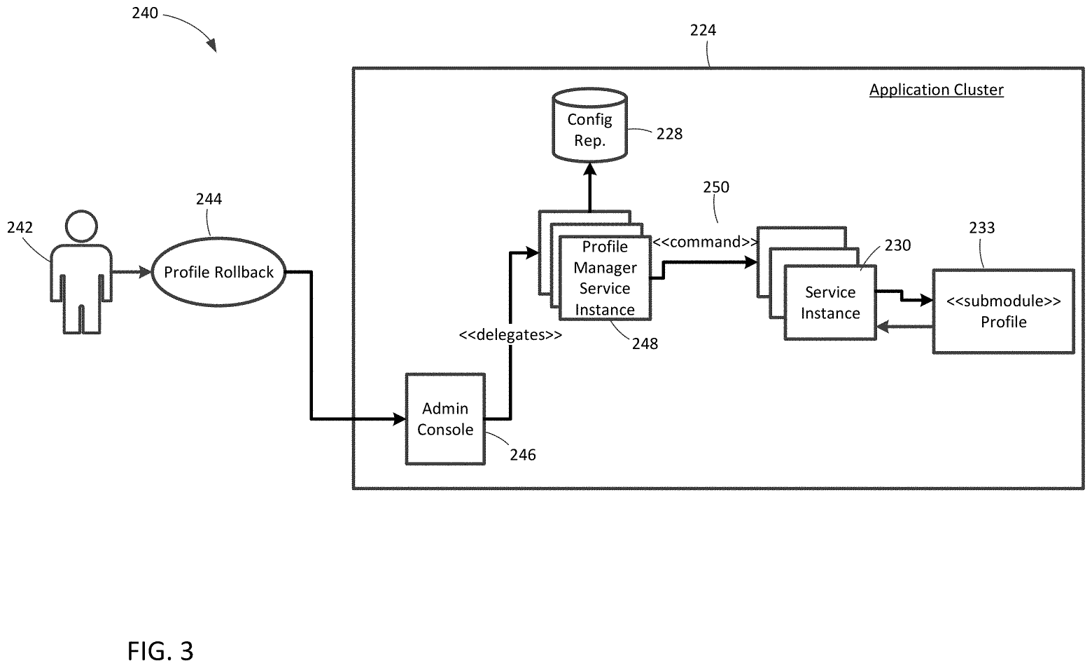

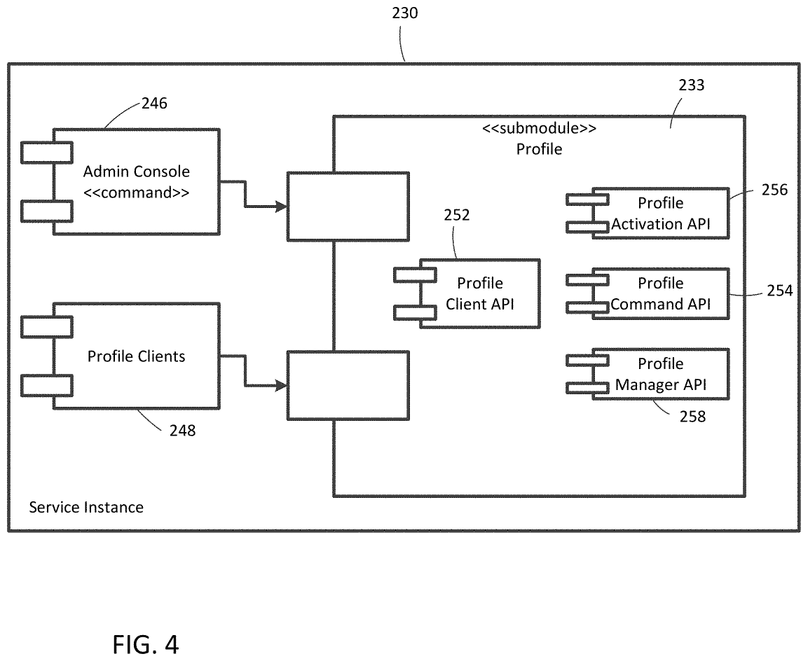

FIG. 3 illustrates an embodiment of a system for managing profiles and profile updates, such as system 200, and particularly a profile rollback 240 process. The profile rollback process 240 may be used, for example, to rollback a currently-active profile to the last good version for any number of reasons that will be evident to those skilled in the art. In some embodiments, profile rollback 240 may include an operator 242 issuing a profile rollback command 244 that may be intercepted via an administrative console interface 246. In some embodiments, the administrative console interface 246 may identify the profile version change and, via APIs, delegate steps to a profile manager service instance 248 or profile manager change module (see, e.g., FIG. 4). The profile manager service instance 248 may update the configuration repository 228 to reflect the changes in the active profile. The profile manager service instance may also issue a command 250 to profile dependent service instances 230 for configuration refresh, for example, from the profile submodule 233 to reload a previous profile version.

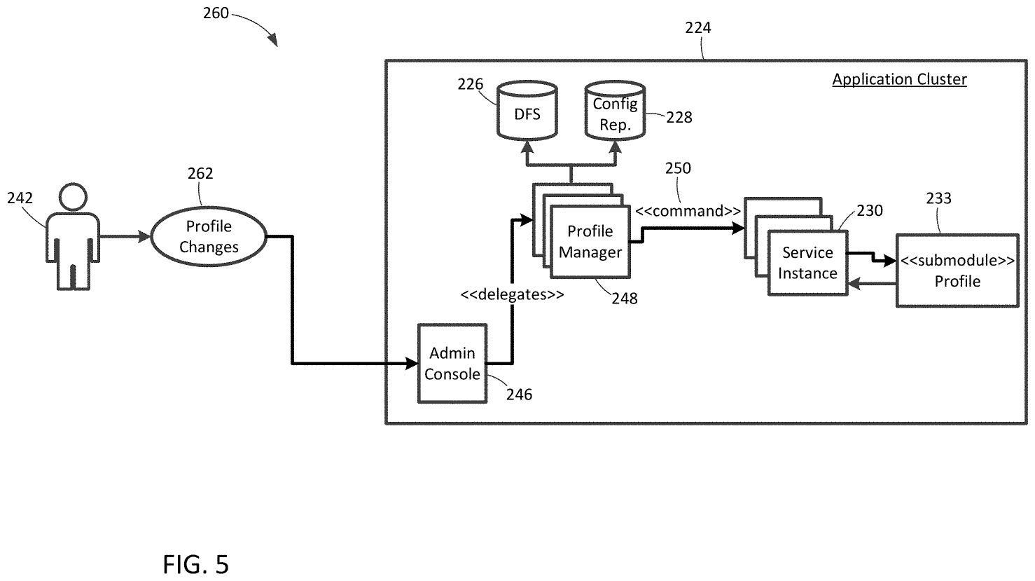

FIG. 4 illustrates an embodiment of a service instance, such as the service instance 230 shown in FIG. 3, and the interaction and functionality of certain profile APIs in that context. In some embodiments, the profile submodule 233 may have APIs that may be used to expose functionality offered to various profile actors. For example, profile client APIs 252 may be exposed for consumption of the profile data by the respective service functionality. In some embodiments, client APIs 252 may by mapped to the underlying data model and may expose the requisite access to data stored within the respective in-memory datastore file associated with the profile. In some embodiments, the profile submodule 233 may also expose profile command APIs 254 that may be integrated with a service framework command interface. The command APIs 254 may allow a system administrator to issue commands that may have a real time impact on an active profile. For example, the commands “config refresh” may refresh the profile version to match the version marked as current by a cluster-wide configuration storage repository. In some embodiments, invoking a command API of some or all of the services in a cluster may allow the services consuming the profile information to do a refresh/activation action and the other services may ignore the command. In some embodiments, watchers may be implemented within services to monitor profile changes. In some embodiments, the profile submodule 233 may include profile activation APIs 256 that may manage profile versions to be activated in the future. In some embodiments, the profile submodule 233 may include profile manager APIs 258 that may manage profile version changes, such as attribute changes during operator overrides (see, e.g., FIG. 5). Profile manager APIs 258 may also manage profile attribute change related to keeptrack client attributes, for example, for rollback operations. The profile manager APIs 258 may also purge operator changes, for example, due to additional changes supplanting prior changes or due to time-based expiry. Of course, those skilled in the art will recognize that the APIs listed herein may execute additional functions and that more or fewer APIs than those listed herein may be used in accordance with the disclosure.

FIG. 5 is a diagram illustrating an embodiment of an operator driven change operation 260 that may be implemented within the system for managing profiles and profile updates 200. In some embodiments, the operator 242 may initiate operator driven profile changes 262 using the admin console interface 246 in the application cluster 224 to access the profile manager service instance or profile manager change module 248. In some embodiments, the profile manager change module 248 may include a user interface that may display a current active profile version. The operator 242 may use the module 248 to choose a profile version and access data across various buckets. The operator 242 may additionally choose files and/or attributes to be changed for the chosen client profile. In some embodiments, the user interface for the profile manager change module 248 may display current values for the chosen field and/or attribute(s) and provide options to update or otherwise change the value(s). In some embodiments, the module 248 may receive a selection of a value or values and receive a command to save the changes (e.g., or automatically save in some embodiments). When saved, in some embodiments, a new minor version of the client profile may be created reflecting the changes or updates.

In some embodiments, an operator may be presented with a plurality of options to configure how operator overrides occur. In some embodiments, all or some of the options may all be presented to an operator for selection. In other embodiments, options may be presented depending on the particular profile or type of profile, or based on the type of changes that are being implemented with the overrides. One option may be to Keep Track, which may include keeping track of changes and keeping them applied until those changes are reflected in a daily or otherwise periodic profile rollout from a source. Another option may be Keep Track+Time-based Expiry, which may keep track of changes until a predetermined or selected time expires or the changes are reflected in a daily or otherwise periodic profile rollout from a source. In some embodiments, an operator may select the Keep Track or Keep Track+Time-based Expiry options for more high-risk checks that may result in relatively severe profile changes. Another option may be not to keep track at all and implement the changes. In some embodiments, an operator may choose not to keep track for relatively minor profile changes, or for changes that are fairly common. In some embodiments, an operator may only be allowed to override specific profile values, which may differ per client, or per type of profile, or permissions for the particular operator. In some embodiments, the operator may then choose the new minor version of the profile to make it the active version.

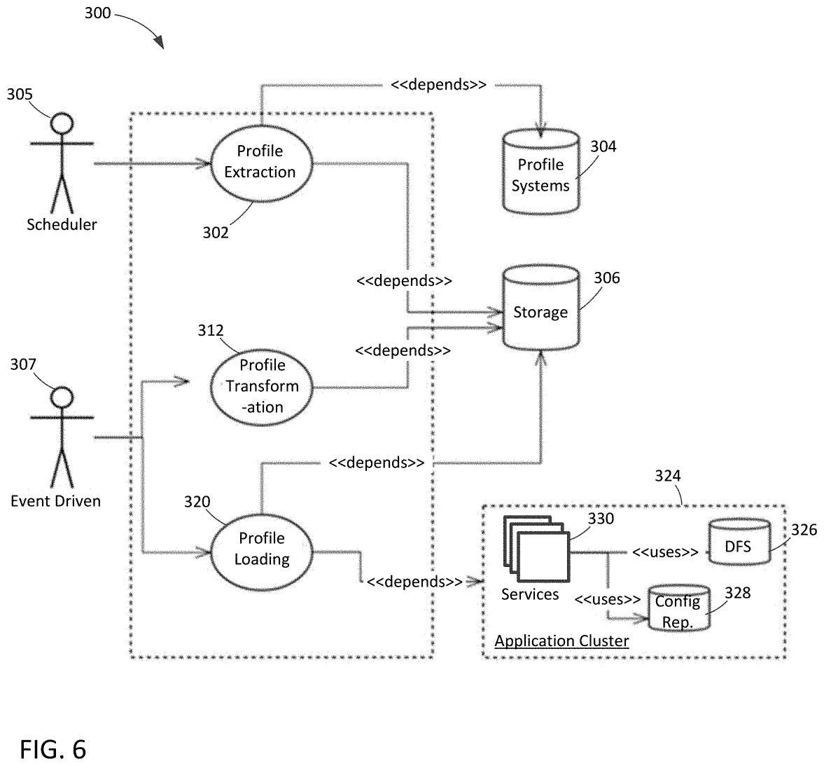

FIG. 6 is a process diagram illustrating an embodiment of a practical application of a system for managing profiles and profile updates, such as system 100 or system 200, which may be referred to as a profile processing pipeline 300. It should be understood that certain features shown in the profile processing pipeline 300 of FIG. 6 may be similar to features shown and described with respect to FIG. 2, and may share similar characteristics even if not reiterated in the context of FIG. 6. In the profile processing pipeline 300, in some embodiments, there may be multiple stages and multiple actors acting at each stage to move profile data down the pipeline. In some embodiments, a scheduler 305 (e.g., scheduling software) may schedule the profile extraction 302 to run on periodic basis, such as every day, week, hour, etc. Profile extraction 302 may include extracting client profiles from a profile systems storage or database 304, converting the profiles to a format that may be readable by an application cluster (e.g., DSL files), and storing the converted profiles in a storage repository 306 (e.g., Artifactory or FTP). The profile extraction 302 process is described in more detail with relation to FIG. 2. In some embodiments, a defined “handshake” model may exist between the profile extraction process 302 and profile transformation 312.

In some embodiments, this handshake model may include using a common namespace/version scheme to map the DSL output of the profile extraction process 302, and the metadata output to that process. In some embodiments, the namespace/version scheme for the DSL files in the storage repository 304 may be as follows:

<<base path>>/app_profile_dsl/<<date>>/<<version>>/<<ProfileEntity>>.profile

The profile processing pipeline 300 may, in some embodiments, generally follow version semantic model. For example, an “X.Y.Z” semantic model where:
X—major version that indicates the version is released from profile systems.
Y—minor version that indicates the version for changes as part of Keep Track attributes.
Z—patch version that indicates the version for operator related direct changes.

The metadata output may, in some embodiments, include one metadata file mapped for each DSL file. One example of the metadata file name convention may be:

META-<<ProfileName>>.yml

In some embodiments, the metadata file may include at least a DSL file name, the date generated, the number of records, the size of file, the activation date, and the activation time. Of course, these are only examples of metadata information and those skilled in the art will recognize that additional data may be included and that many other naming schemes for both DSL and metadata files may be suitable.

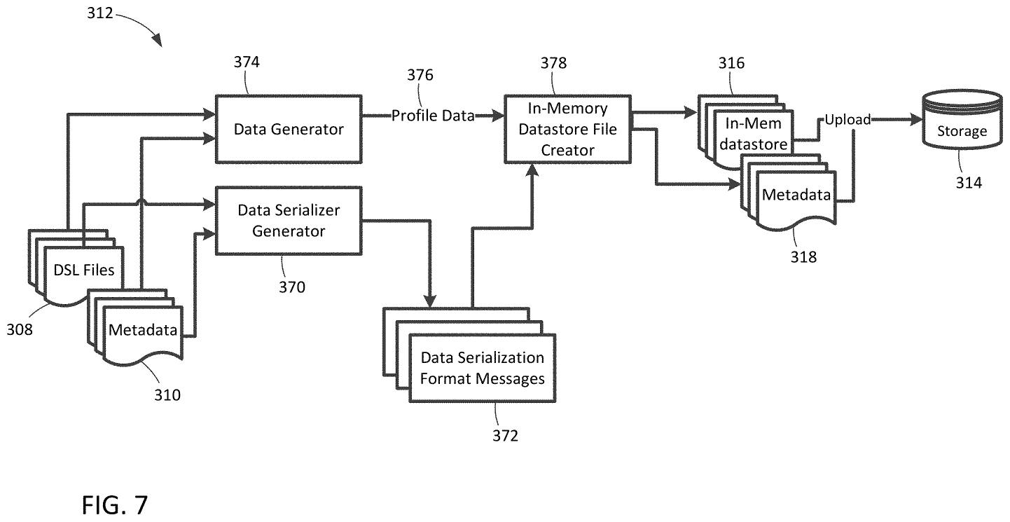

The profile transformation process 312 and the profile loading process 320 may, in some embodiments, be driven by an event 307 (e.g., operator override, rollback, etc.). An embodiment of the profile transformation process 312 shown in FIG. 6 is illustrated in further detail in FIG. 7. The DSL files 308 and the respective metadata 310 may be read from their location in the storage repository 306. In some embodiments, the location, date, and/or version to be read is passed as an input to the transformation process 312. In some embodiments, DSL verification checks may be done to verify the accuracy and correctness of the DSL files 308, and the metadata 310 may include the information for such validation. In some embodiments, a data serializer generator sub-process 370 may convert the DSL file 308 data into relevant data serialization format messages 372 (e.g. protocol buffer messages or protobuf messages), and a data generator sub-process 374 may read the DSL files 308 and metadata files 310 to create profile data 376. In some embodiments, an in-memory datastore creator sub-process 378 may read the proto messages 372 in conjunction with the profile data 376 and create specific in-memory datastore files 316 (i.e., embedded key/value database files) and metadata files 318. The profile transformation process 312 may also include uploading the in-memory datastore files 316 and associated metadata files 318 to a storage repository 314, for example, to an file storage cluster location for the deployment of artifacts. In some embodiments, one file may be mapped to proto messages for a particular entity, which may reduce the number of message files and may reduce the likelihood of overloading the system.

In some embodiments, the in-memory datastore files 316 and metadata files 318 may use a naming convention. For example, the in-memory datastore files 316 may follow the naming convention:

<<basepath>>/app_profile_binary/<<date>>/<<version>>/<<profileName>
>.in-memory datastore

The metadata 318 files may follow the naming convention:

META-<<ProfileName>>.yml

In some embodiments, the metadata file may include at least an in-memory datastore file name, the date generated, the number of records, the size of file, the activation date, and the activation time. Of course, these are only examples of metadata information and those skilled in the art will recognize that additional data may be included and that many other naming schemes for both in-memory datastore files and metadata files may be suitable.

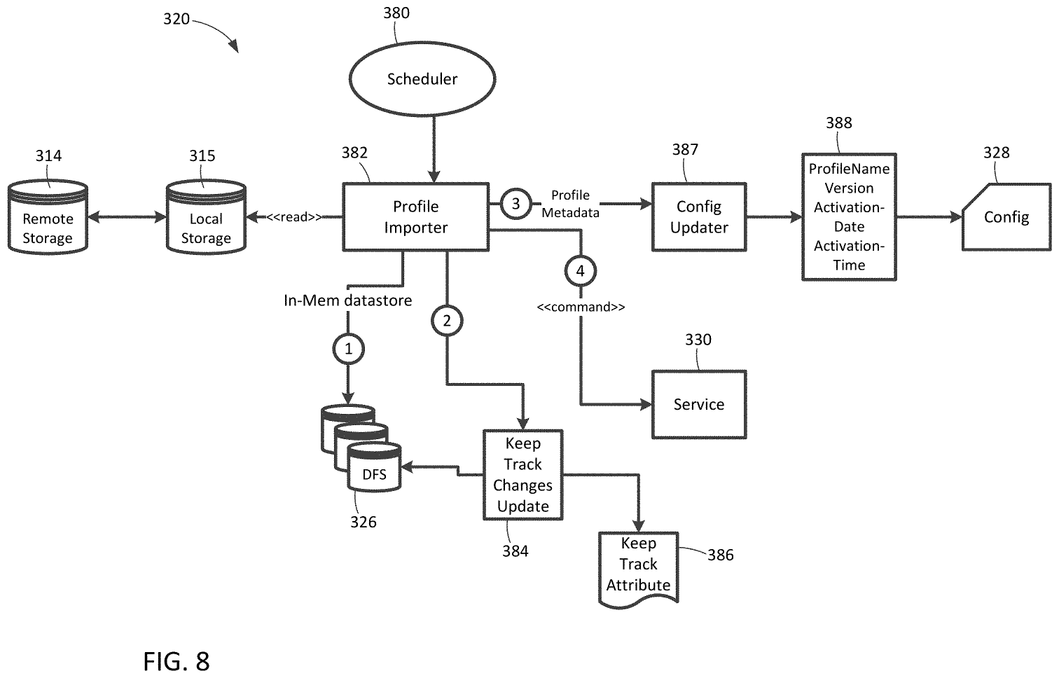

An embodiment of the profile loading process 320 shown in FIG. 6 is illustrated in further detail in FIG. 8. In some embodiments, when the profile transformation process 312 is finished, the in-memory datastore files 316 and associated metadata 318 may be uploaded to a storage repository 314 (e.g., FIG. 7). In some embodiments, the storage repository may be remote storage with respect to a local system, and a local storage repository 315 may replicate the remote storage 314 for local use. For example, in embodiments where the storage repository 314 is an third-party storage repository, an third-party High Availability (HA) solution may be utilized to make the stored profile data available in a local storage repository, such as local storage repository 315.

In some embodiments, a scheduler 380 (e.g., a time-based job scheduler such as Cron) may trigger a profile loading operation. The profile loading operation may invoke a bolt-profile importer 382 to copy the in-memory datastore files 316 from the storage repository 315 to a local DFS cluster 326 (e.g., kubernetes). In some embodiments, the in-memory datastore file 316 may be copied in two places: one for operator changes (writable), and one for shared read-only use by services consuming profile information. The profile loading process 320 may also include, at 384, checking for Keep Track related changes to the profile as applicable. For example, in cases where Keep Track changes may not be in regular profile updates, the changes may be applied on the incoming profile data. For cases where Keep Track Changes may already be in regular profile updates, the relevant Keep Track Changes may be expired. In some embodiments, if the Keep Track Changes are past their expiry date, then they may be ignored. In some embodiments, any Keep Track attributes 386 may be stored.

Upon creating the copy of the in-memory datastore file 316, the in-memory datastore file-profile importer 382 may invoke a config updater process 387, which may generate configuration information 388 (e.g., Profile name, version, activation date, activation time) that may be used for profile-consuming services. The config updater process 387 may also update the local configuration storage repository 328 to reflect the profile changes in the configuration. In some embodiments, once the local configuration storage repository 328 is updated, the profile importer 382 may send instructions (e.g., via command APIs), for all the services 330 that may be consuming the profiles that changes to the profile have occurred.

In some embodiments, the in-memory datastore files 316 in the DFS may use a naming convention. For example, the in-memory datastore files 316 may follow the naming convention:

<<base path>>/app_profile/<<date>>/<<version>/

In some embodiments, the configuration (i.e., config) may be updated for mapping the new in-memory datastore files for loading and activation. For example:

<<base namespace>>/app_profile/<<Profile Name>>

This mapping may reflect the current active profile version, the previous active version, the load version, etc.

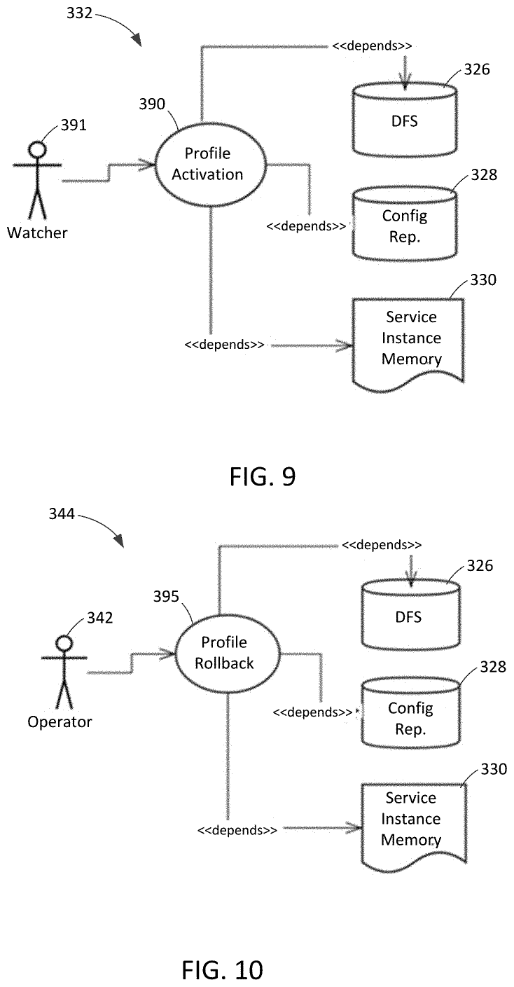

FIG. 9 is a diagram of an embodiment of a profile activation process 332, similar to the profile activation 232 described with reference to FIG. 2. As described above with reference to the profile loading process 320 in FIG. 8, the profile loading process may copy the profile information in the in-memory datastore file 316 in the DFS 326 in two locations and update the config information accordingly in the configuration repository 328. In some embodiments, a profile-consuming service 330 may be informed about profile changes, for example, through command APIs, which may cause a profile activation submodule 390 to activate. The profile activation submodule 390 may then open the bolt-profile in-memory datastore file 316 from the DFS 326 in a memory mapped mode. The profile activation submodule 390 may “point” to the in-memory datastore file 316 using a future pointer. In some embodiments, the profile activation may occur at a predetermined time or at a time selected by a watcher 391, or may occur substantially immediately in some embodiments. In any event, in some embodiments, at the time of activation, the profile pointer references may be changed and the current, updated profile may be chosen appropriately to reflect the updates.

FIG. 10 shows a diagram of another embodiment of a profile rollback operation 344 similar to the profile rollback 244 described with respect to FIG. 3. The profile rollback operation 344 illustrated in FIG. 10 may represent steps for operator driven profile rollback changes. In some embodiments, an operator 342 may use a profile rollback module 395 select the active profile version that the operator would like rolled back, for example, to the last known version. In some embodiments, service management APIs may invoke profile command APIs (see FIG. 4) that may update the configuration on the configuration repository 328 for the relevant active profile version changes. In some embodiments, the service instance 330 may recognize the changes in the relevant configuration and, once the service instance receives an initiation instruction, may load and activate the new profile version selected for the rollback. In some embodiments, operator driven operations may be monitored and audited. In some embodiments, an operator 342 may make the rollback changes to for every data center where clients are connecting. In some embodiments, the changes in the rollback operation may be pushed across multiple data centers at substantially the same time.

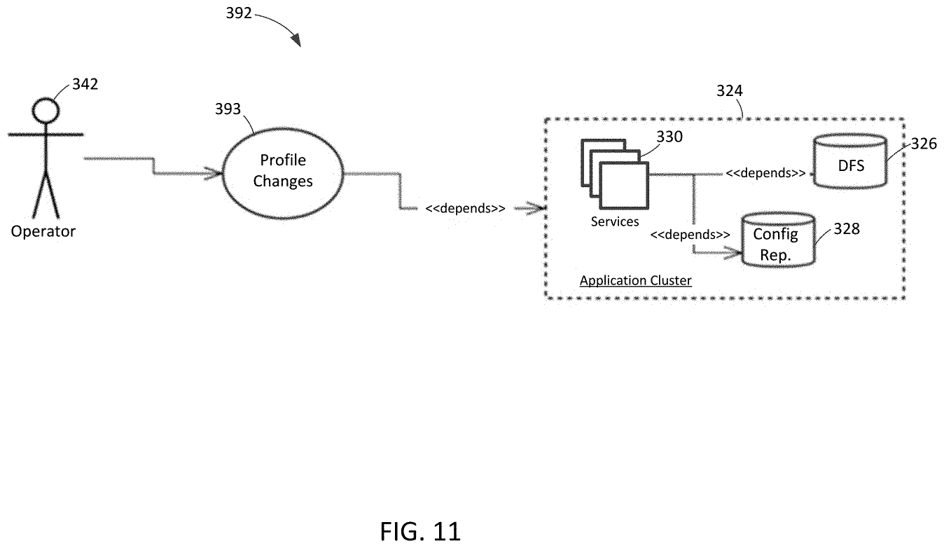

FIG. 11 is a diagram of an embodiment of a practical application of an operator driven profile update 392. In some embodiments, the operator 342 may use a profile change module 393 to select a profile version to be updated or otherwise changed. In some embodiments, a copy of the profile in-memory datastore file (such as in-memory datastore file 316 in FIG. 7), may be made in the DFS 326 within the application cluster 324. In some embodiments, a patch version scheme may be followed. For example, if the profile version is v1.0.0, then the patch version may be v.1.0.1; however, those skilled in the art will recognize that other suitable schemes may be followed. The operator 342 may select the attributes of the profile that may need to be updated or changed, and a service management API may invoke profile command APIs to open the profile in-memory datastore file and update the relevant fields to reflect the operator selected changes. In some embodiments, the operator 342 may then prompt and make the patch profile as the active profile. Service management APIs may invoke profile command API that may update the configuration in the configuration repository 328 for the relevant active profile version changes. In some embodiments, the service 330 may be informed of the changes in the configuration through command APIs. Once the service 330 receive the command indicating the changes, the service may load and activate the new patch profile version. In some embodiments, all operator driven operations, such as the operator driven profile updates 392, may be monitored and audited. In some embodiments, an operator 342 may make the profile changes to for every data center where clients are connecting. In some embodiments, the changes may be pushed across multiple data centers at substantially the same time.

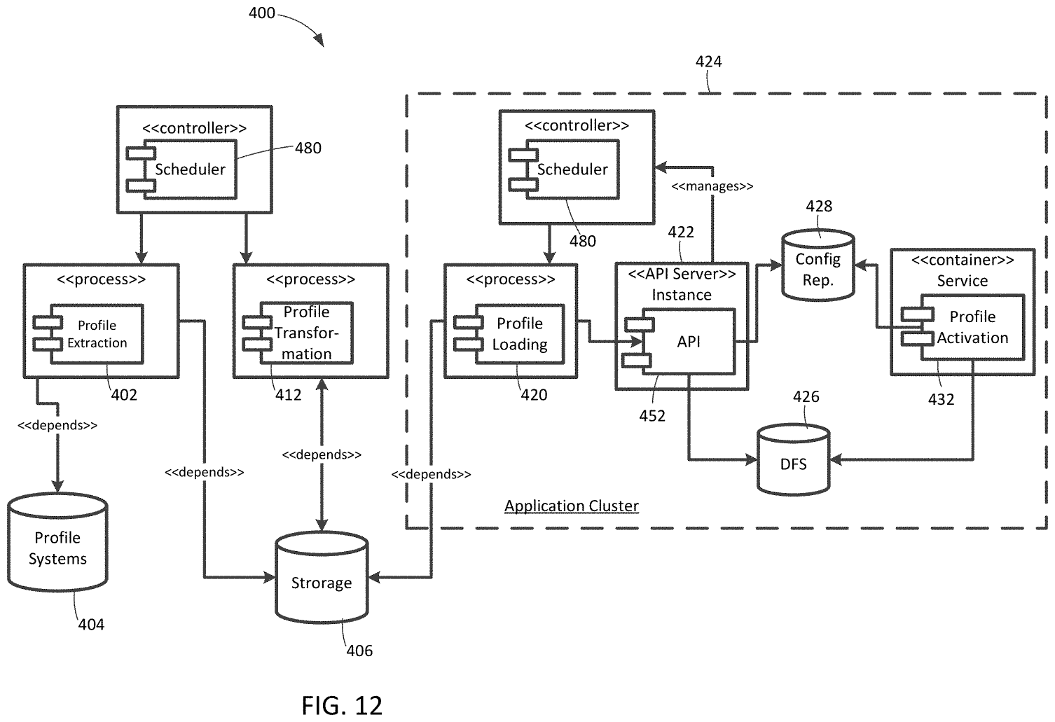

FIG. 12 shows a process view of an embodiment of a profile processing diagram 400 that may be utilized by the system for managing profiles and profile updates described herein. The process view in FIG. 12 may represent the features illustrated in the logical view of the embodiment of the system for managing profiles and profile updates 200 in FIG. 2. A scheduler 480 e.g., a time-based job scheduler such as Cron) may trigger a profile extraction process 402 to extract one or more profiles from a profile systems storage repository 404. The profile extraction process 402 may convert the profile to a readable format and store the profile in a storage repository 406. The scheduler 480 may also trigger a profile transformation process 412 that may read the converted profile from the storage repository 406 and transform the profile as described herein with respect to FIG. 2 and FIG. 7. The scheduler 480 may also trigger a profile loading process 420 as further described with respect to FIG. 2 and FIG. 8. In some embodiments, an API server 422 may invoke one or more APIs using containerization software to copy profile files to the DFS 426 and add profile metadata to a configuration repository 428, such as described above with reference to FIG. 2. In some embodiments, a profile activation process 432 may map the relevant profile file in the DFS 426 based on its respective metadata stored in the configuration repository 428, such as described above with reference to FIG. 2 and FIG. 9.

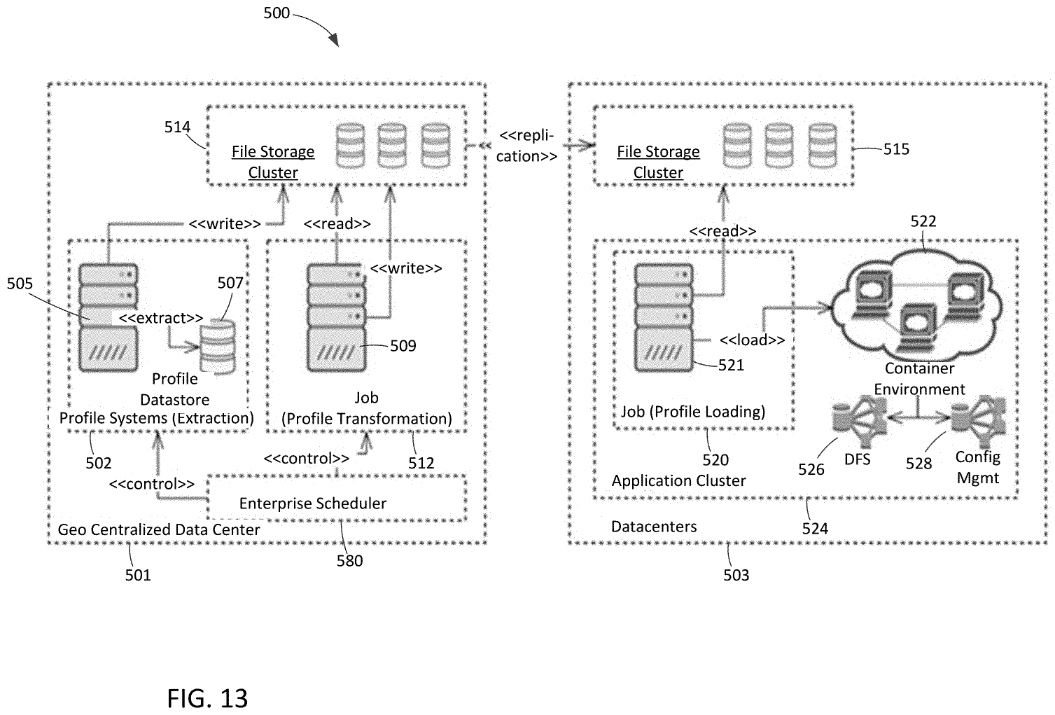

FIG. 13 is a high level physical view of an embodiment of a computing environment 500 that may be used to implement the system for managing profiles and profile updates described herein. The computing environment 500 features on which many of the processes described herein may run, although those skilled in the art will recognize that other suitable computing environments may be as well. The computing environment 500 includes both a geo centralized data center 501 and at least one application datacenter 501. In some embodiments, the geo centralized data center 501 may include a remote file storage cluster 514, which may be replicated in a local file storage cluster 515 included in the at least one application datacenter 503. The geo centralized data center 501 may also include a profile system 502 for extraction, a job (profile transformation) system 512, and an enterprise scheduler 580. The profile system 502 may include an extraction server 505 and a profile datastore 507. The enterprise scheduler 580 may control the profile systems for extraction and the profile transformation system 512. In some embodiments, the extraction server 505 may extract profile data from the profile datastore 507, convert the file format as otherwise described herein, and store the converted profile in a storage repository such as the file storage cluster 514. The profile transformation system 512 may include a transformation server 509, which may read profile data from the remote file storage cluster 514, transform the data as otherwise described herein with respect to FIG. 2 and FIG. 7, and write the updated profile data onto the remote file storage cluster.

The application datacenter 503 may include one or more application cluster 524 and a local file storage data cluster 515. The local file storage data cluster 515 may replicate the profile data stored on the remote file storage data cluster 514. The application cluster 524 may include a profile loading system 520, a containerization software platform cluster 522 (e.g., Kubernetes, Docker Enterprise), a distributed file system (DFS) 526, and a configuration management storage repository or module 528. The profile loading system 520 may include a loading server 521 that may read profile data from the local file storage cluster 515 and load it onto the container orchestrator cluster 522. The container orchestrator cluster 522 may communicated with the DFS 526 and the configuration management repository 528 as described above with reference to FIG. 2 and FIG. 8.

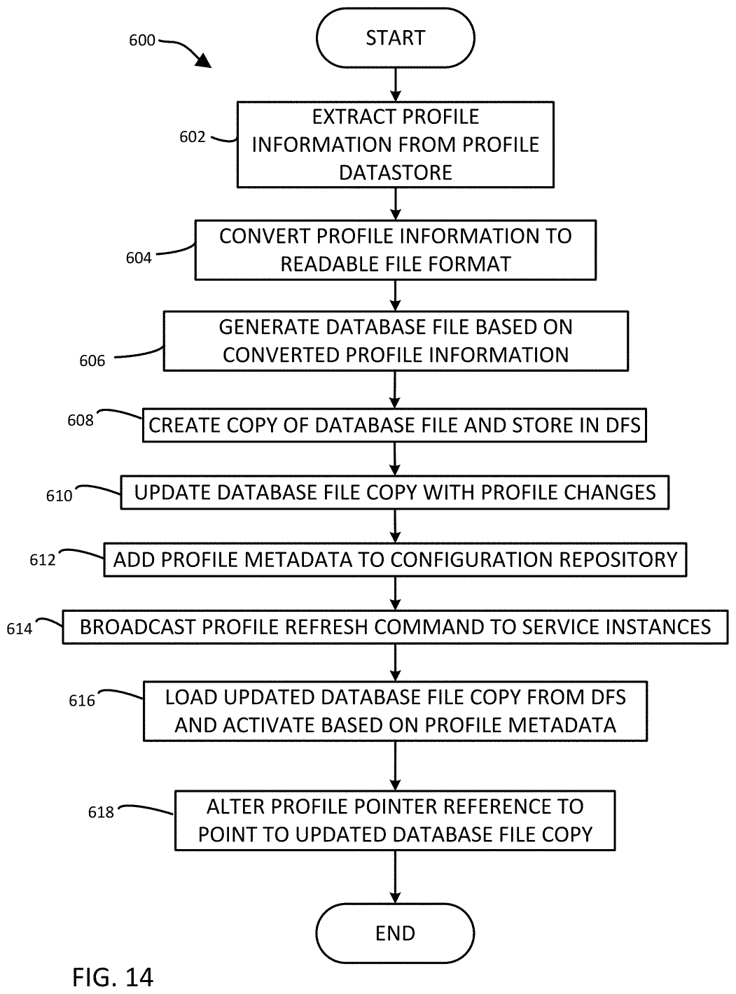

FIG. 14 is a flow chart illustrating an embodiment of a method 600 of using the system for managing profiles and profile updates described herein. At 602, the method may include extracting profile information from a profile datastore, such as the profile system storage or database 204 shown and described in reference to FIG. 2. At 604, the method may include converting the extracted profile information to a readable file format, for example, a DSL format and storing the file in, for example, a storage repository such as DSL storage 206 shown and described with reference to FIG. 2. At 606, the method may include generating a database file, such as an in-memory datastore file, based on the converted profile information and storing the database file in a storage repository such as storage repository 214 as shown and described in reference to FIG. 2.

At 608, the method may include creating a copy of the database file and storing the database file copy in a distributed file system (DFS), such as the DFS 226 in FIG. 2. At 610, the method may include updating the database file copy with profile changes, such as routine profile changes or profile changes initiated by an operator. At 612, the method may include adding profile metadata that may be associated with the profile information to a configuration repository, such as configuration repository 228. At 614, the method may include broadcasting a profile refresh command to one or more service instances, such as service instances 230, that may be associated with the underlying profile. At 616, the method may include loading the updated database file copy from the DFS and activating the profile copy based on the profile metadata. At 618, the method may include altering a profile pointer reference to point to the updated database file copy.

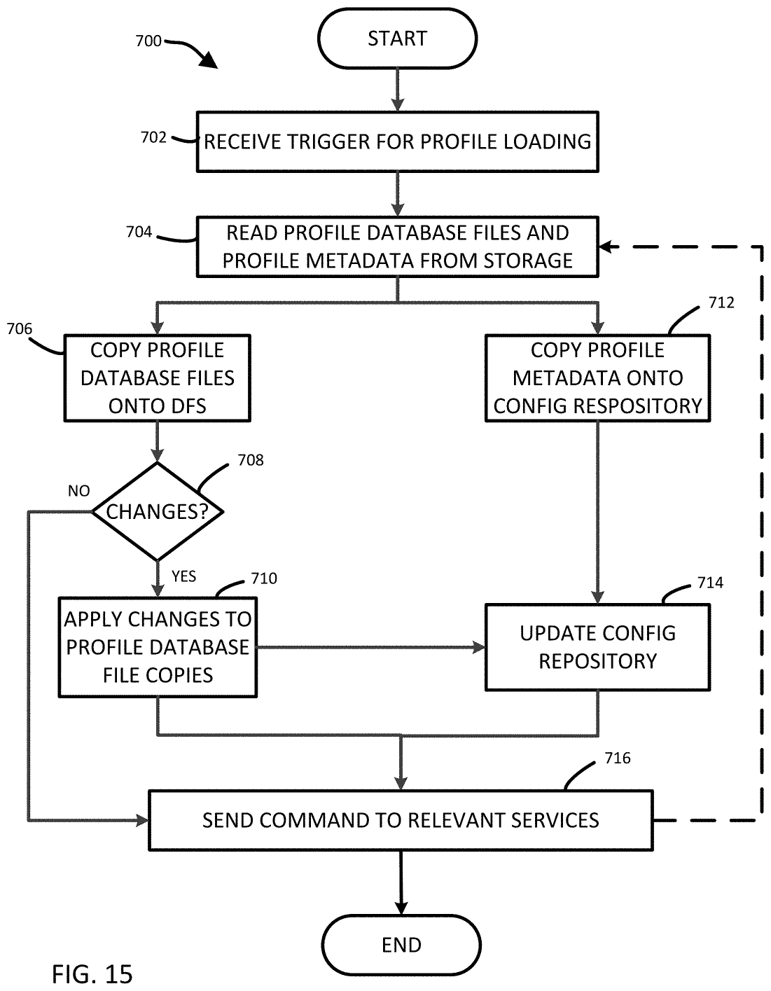

FIG. 15 is a flow chart illustrating an embodiment of a method 700 of loading an updated profile in the system for managing profiles and profile updates described herein. At 702, the method 700 may include receiving a trigger for profile loading associated with a client profile. In some embodiments, the trigger may be received in relation to changes detected in a client profile, via a manual initiation action taken by an operator, a job scheduler, etc. At 704, the method 700 may include reading one or more profile database files and profile metadata from a storage repository, such as storage repository 214. At 706, the method 700 may include copying the profile database files onto a DFS, such as DFS 226 and, at 712, copying the profile metadata onto a configuration repository, such as configuration repository 228. At 708, the method 700 may include determining whether any changes may be made to the client profile, either via operator initiated changes, routing updates, etc. If yes, at 710, the method 700 may include applying the changes to the profile database file copies and, at 714, updating metadata in the configuration repository to reflect the profile changes. At 716, the method 700 may include sending a profile refresh command to any services that may be associated with the client profile. In some embodiments, the method 700 may be followed by profile activation, such as shown and described with reference to FIG. 2 and FIG. 9.

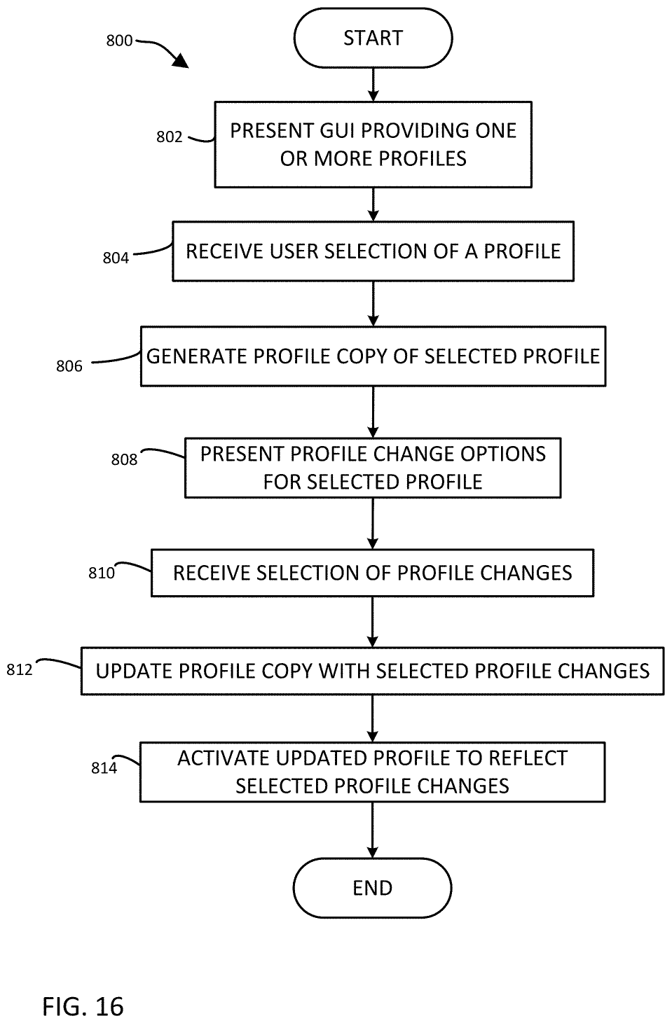

FIG. 16 is a flow chart illustrating an embodiment of a method 800 of implementing operator initiated changes in the system for managing profiles and profile updates described herein, such as with reference to FIG. 5. At 802, the method 800 may include presenting or otherwise displaying a graphical user interface (GUI) providing one or more client profiles that an operator may select using a computing device, such as computing device 55 shown and described with reference to FIG. 17. At 804, the method 800 may include receiving a user selection of a profile via the GUI and, at 806, generating a profile copy of the selected client profile. At 808, the method 800 may include presenting one or more profile change options to the operator via the GUI and, at 810, receiving a selection of at least one of the one or more profile changes by the operator via the GUI. In some embodiments, the profile changes may related to any of a variety of profile fields, such as those listed in more detail herein. At 812, the method 800 may include updating the profile copy with the selected profile changes and, at 814, activating the updated profile to reflect the selected profile changes. It should be understood that, although only the method in FIG. 8 explicitly describes the use of a GUI to present and receive information to and from an operator or other user, other embodiments of the system described herein may include presentation and receiving of information using suitable graphical user interfaces.

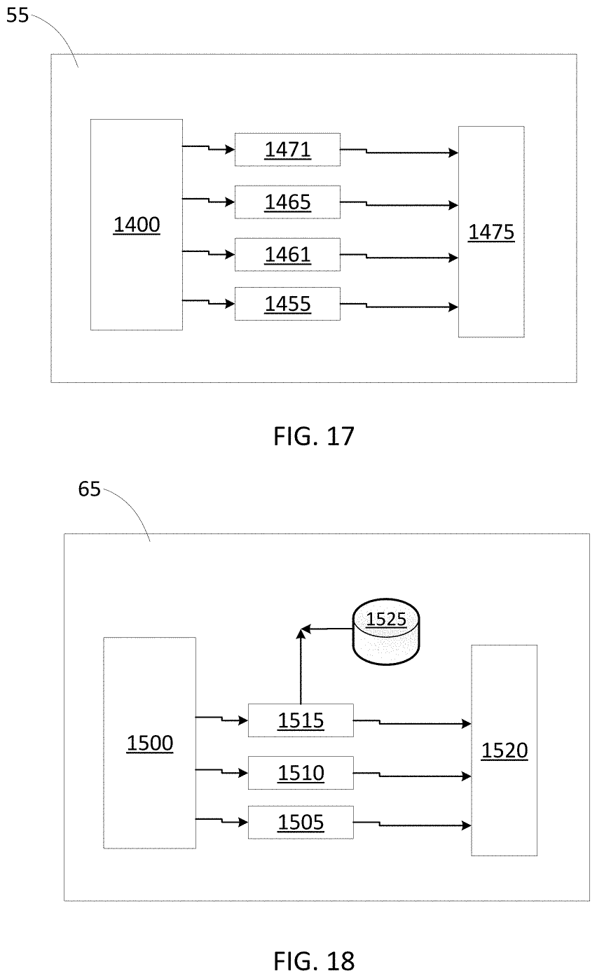

FIG. 17 is a simplified illustration of the physical elements that make up an embodiment of a computing device 55 and FIG. 18 is a simplified illustration of the physical elements that make up an embodiment of a server type computing device 65, such as the extraction server or API server described herein, but other types of servers such as a client server, an issuer servers, a token server, etc., may reflect similar physical elements in some embodiments. Referring to FIG. 17, a sample computing device 55 is illustrated that is physically configured to be part of a computing system through which the system and method for managing profile updates may be run. The portable computing device 55 may have a processor 1451 that is physically configured according to computer executable instructions. In some embodiments, the processor can be specially designed or configured to optimize communication between a server and the computing device 55 relating to the system and methods for profile updates described herein. The computing device 55 may have a portable power supply 1455 such as a battery, which may be rechargeable. It may also have a sound and video module 1461 which assists in displaying video and sound and may turn off when not in use to conserve power and battery life. The computing device 55 may also have volatile memory 1465 and non-volatile memory 1471. The computing device 55 may have GPS capabilities that may be a separate circuit or may be part of the processor 1451. There also may be an input/output bus 1475 that shuttles data to and from the various user input/output devices such as a microphone, a camera 59, a display 56, or other input/output devices. The portable computing device 55 also may control communicating with the networks, such as a digital communication network, either through wireless or wired devices. Of course, this is just one embodiment of the portable computing device 55 and the number and types of portable computing devices 55 is limited only by the imagination.

The physical elements that make up an embodiment of a server 65, such as an extraction server, are further illustrated in FIG. 18. In some embodiments, the server is specially configured to run the system and methods for managing profile updates as described herein. At a high level, the server 85 may include a digital storage such as a magnetic disk, an optical disk, flash storage, non-volatile storage, etc. Structured data may be stored in the digital storage such as in a database. More specifically, the server 65 may have a processor 1500 that is physically configured according to computer executable instructions. In some embodiments, the processor 1500 can be specially designed or configured to optimize communication between a portable computing device, such as computing device 55, and the server 65 relating to the system and methods for managing profile updates as described herein. The server 65 may also have a sound and video module 1505 which assists in displaying video and sound and may turn off when not in use to conserve power and battery life. The server 65 may also have volatile memory 1510 and non-volatile memory 1515.

A database 1525 for digitally storing structured data may be stored in the memory 1510 or 1515 or may be separate. The database 1525 may also be part of a cloud of servers and may be stored in a distributed manner across a plurality of servers. There also may be an input/output bus 1520 that shuttles data to and from the various user input devices such as a microphone, a camera, a display monitor or screen, etc. The input/output bus 1520 also may control communicating with networks, such as a communication network and a payment network, either through wireless or wired devices. In some embodiments, a card template controller for running a card template service or API may be located on the computing device 55. However, in other embodiments, the card template controller may be located on a server 65, or both the computing device 55 and the server 65. Of course, this is just one embodiment of the server 65 and additional types of servers are contemplated herein.

In some embodiments, a business may set up and operate client profiles using a containerized service model, or application containerization. In such embodiments, application containerization may be an operating system (OS) level virtualization method that may be used to deploy and run distributed applications without launching an entire virtual machine for each application. In some embodiments, software packages call “containers” may be isolated from one another and include bundles of each container's own application, tools, libraries, configuration files, etc. In some embodiments, all containers may be run by a single OS kernel. In some embodiments, containers may be created from images that specify their precise contents.

The various participants and elements described herein may operate one or more computer apparatuses to facilitate the functions described herein. Any of the elements in the above-described Figures, including any servers, user terminals, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++ or Perl using, for example, conventional or object-oriented techniques. In some examples, the at least one processor may be specifically programmed.

The software code may be stored as a series of instructions, or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware and a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed (or physically configured) to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, the system and the methods described herein may be configured to provide dynamic updates to client profiles. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. A computer-implemented method comprising:
extracting profile information for at least one profile from a profile datastore;
converting the profile information into a readable file format;
storing the converted profile information in a storage repository;
creating at least one database file based on the converted profile information;
copying the at least one database file to create a database file copy;
updating the database file copy with one or more profile changes to be made to the at least one profile;
loading the updated database file copy so as to generate at least one updated profile, wherein the updated database file copy is mapped according to metadata in the updated database file copy; and
altering a profile pointer reference to point to the updated database file copy so as to activate the at least one updated profile, wherein activating the at least one updated profile activates the one or more profile changes;
wherein the method is performed using one or more processors.

2. The method of claim 1 further comprising converting the profile information into a readable file format.

3. The method of claim 1 further comprising converting the profile information to a domain specific language (DSL) format.

4. The method of claim 1, wherein the profile information includes meta data files.

5. The method of claim 1, wherein the profile information includes domain specific language (DSL) files and meta data files.

6. The method of claim 5, wherein generating the at least one message file from the profile information includes converting data in the DSL files into at least one binary data serialization format message.

7. The method of claim 6, wherein generating profile data includes is based on the DSL files and meta data files of the profile information.

8. The method of claim 1, wherein the at least one database file is an embedded key/value database file.

9. The method of claim 1, wherein the profile data includes at least one of:
an acquirer bank identification number (BIN);
one or more account numbers;
one or more ISO BINs;
one or more routing BINs;
one or more acquirer BINs;
one or more agent bank numbers;
one or more agent chain numbers;
one or more store numbers;
one or more merchant names; or one or more merchant category codes.

10. The method of claim 1, wherein the loading the updated database file copy so as to generate at least one updated profile occurs via an application protocol interface (API) for containerization/non-containerization software.

11. A computer-implemented method comprising:
presenting, via one or more processors, a graphical user interface to a user, the graphical user interface providing one or more profiles for selection;
receiving, via the graphical user interface, a user selection of a profile of the one or more profiles;
in response to the user selection of the profile, generating, via the one or more processors, a profile copy of the user selected profile;
presenting, via the one or more processors, one or more profile change options associated with the user selected profile;
receiving, via the graphical user interface, a user selection of at least one of the one or more profile change options;
based on the user selection of the at least one of the one or more profile change options, updating, via the one or more processors, the profile copy of the user selected profile to reflect the one or more profile change options and create an updated profile; and
activating, via the one or more processors, the updated profile so as to implement the user selection of at the least one of the one or more profile change options.

12. The method of claim 11, wherein activating the updated profile includes changing one or more profile pointer references to indicate the updated profile.

13. The method of claim 11, further comprising generating, via the one or more processors, a log of the user selection of the at least one of the one or more profile change options.

14. The method of claim 13, further comprising:
receiving, via the graphical user interface, a user selection to rollback profile changes made to the updated profile; and
reversing, via the one or more processors, the one or more profile change options.

15. The method of claim 11, wherein the profile copy is a database file.

16. The method of claim 15, wherein updating the profile copy includes changing at least one field of a plurality of fields in the database file configured to reflect the user selection of the at least one of the one or more profile changes.

17. The method of claim 11, wherein the profile copy is an embedded key/value database file.

18. The method of claim 11, wherein activating the profile copy occurs on user selected date.

19. A computer-implemented method comprising:
receiving a trigger for a profile loading process;
reading a profile database file and a profile metadata file from a storage repository, the profile database file being associated with a client profile;
generating a copy of the profile database file and a copy of the profile metadata file;
storing the copy of the profile database in a distributed file system;
storing the copy of the profile metadata in a configuration repository;
identifying one or more requested profile changes associated with the client profile;
applying the one or more requested profile changes to the copy of the profile database file;
updating the configuration repository based on the applied one or more requested changes associated with the client profile; and
transmitting a command to one or more services associated with the client profile, the command including an indication of changes to the client profile;
wherein the method is performed using one or more processors.

20. The method of claim 19, wherein the one or more requested profile changes are received based on an operator selection via a graphical user interface.
